(19) United States
(12) Patent Application Publication
(10) Pub. No.: US 2011/0176005 A1
(43) Pub. Date: Jul. 21, 2011

(54) INFORMATION PROVIDING APPARATUS, INFORMATION PROVIDING METHOD, AND RECORDING MEDIUM

(76) Inventors: Kenichi Kaneko, Tokyo (JP); Tomoko Yoshino, Tokyo (JP)

(21) Appl. No.: 13/122,276

(22) PCT Filed: Sep. 25, 2009
(86) PCT No.: PCT/JP2009/066595

§ 371 Date: Apr. 1, 2011

(30) Foreign Application Priority Data
Oct. 14, 2008 (JP) 2008-265263

(51) Int. Cl. H04N 7/18

(52) U.S. Cl. 348/150; 348/E07.085

(57) ABSTRACT

An information providing apparatus includes an image capturer for capturing an image of a customer which requires a certain time to be consumed at a given location, an attribute information acquirer for estimating an attribute of the customer based on the image captured by the image capturer and acquiring attribute information representative of the estimated attribute, and a customer information output unit for outputting customer information depending on the attribute information acquired by the attribute information acquirer.

### TECHNICAL FIELD

The present invention relates to an information providing apparatus, an information providing method, and a recording medium for providing information useful to a customer based on an image of the customer.

### BACKGROUND ART

One example of technology relevant to the present invention is a customer information collecting and managing method disclosed in Patent document 1. The disclosed customer information collecting and managing method includes acquiring a plurality of successive images of each of customers who are present in a shop and registering attributes (personal features) extracted from the acquired images in a database.

### PRIOR TECHNICAL DOCUMENTS

Patent document 1: JP No. 2004-34861 8A

### SUMMARY OF THE INVENTION

### Problems to be Solved by the Invention

The invention disclosed Patent document 1 suffers the following problems: According to the invention disclosed Patent document 1, merchandise information and accounting information which are held by a POS (Point Of Sales) apparatus and attribute information of customers are recorded. When items of the recorded information are subsequently related and retrieved, they can be used for marketing purposes or the like. However, advertisements displayed on a customer display of the POS apparatus and receipt advertisements cannot be changed depending on customer information because the POS apparatus and the attribute information extractor are separate from each other and hence no real-time data linkage can be established between the POS apparatus and the attribute information extractor.

It is an object of the present invention to provide an information providing apparatus, an information providing method, and a recording medium which are capable of solving the above problems.

### Means for Solving the Problems

To achieve the above object, an information providing apparatus according to the present invention includes an image capturer for capturing an image of a customer who is at a given location during a period of time, an attribute information acquirer for estimating an attribute of the customer based on the image captured by the image capturer and acquiring attribute information representative of the estimated attribute, and a customer information output unit for outputting customer information depending on the attribute information acquired by the attribute information acquirer.

An information providing method according to the present invention includes capturing an image of a customer who is at a given location during a period of time, estimating an attribute of the customer based on the captured image and acquiring attribute information representative of the estimated attribute, and outputting customer information depending on the acquired attribute information.

A recording medium according to the present invention is a computer-readable recording medium recording therein a program for enabling a computer to perform an image capturing process for capturing an image of a customer who is at a given location during a period of time, an acquiring attribute information for estimating an attribute of the customer based on the image captured by the image capturing process and acquiring attribute information representative of the estimated attribute, and a customer information output process for outputting customer information depending on the attribute information acquired by the attribute information acquiring process.

### Advantages of the Invention

According to the present invention, it is possible to provide information suitable for each customer reliably with good timing.

### BRIEF DESCRIPTION OF THE DRAWINGS

FIG. 1 is a view showing the appearance of a POS apparatus according to an exemplary embodiment of the present invention;

FIG. 2 is a block diagram of the configuration of the POS apparatus according to the exemplary embodiment of the present invention;

FIG. 3 is a flowchart of an operation sequence of the POS apparatus according to the exemplary embodiment of the present invention;

FIG. 4 is a flowchart of an operation sequence (supplemental example 3) of the POS apparatus according to the exemplary embodiment of the present invention;

FIG. 5A is a flowchart of an operation sequence (supplemental example 12) of the POS apparatus according to the exemplary embodiment of the present invention; and

FIG. 5B is a flowchart of an operation sequence (supplemental example 12) of the POS apparatus according to the exemplary embodiment of the present invention.

### MODE FOR CARRYING OUT THE INVENTION

A mode for carrying out the invention will be described in detail below with reference to the accompanying drawings.

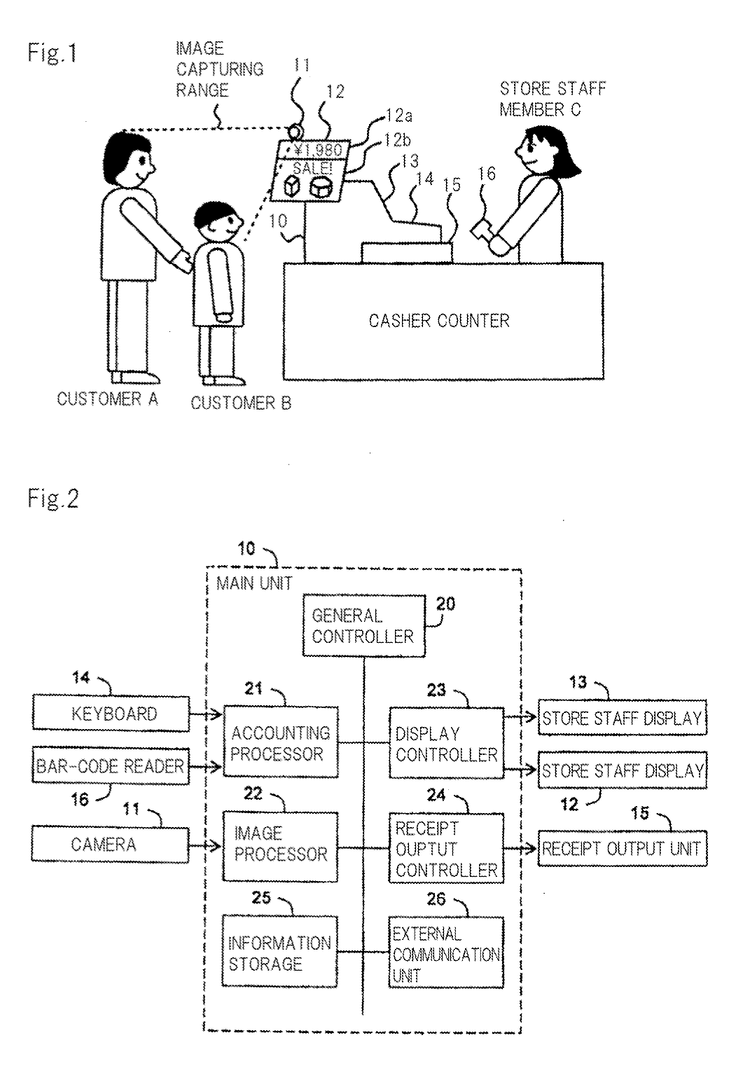

A POS (Point Of Sales) apparatus as an information providing apparatus according to an exemplary embodiment of the present invention will be described by way of example below. The POS apparatus according to the present exemplary embodiment is installed at the cashier counter (checkout) of a shop. FIG. 1 is a view showing the appearance of the POS apparatus according to the present exemplary embodiment. As shown in FIG. 1, the POS apparatus according to the present exemplary embodiment includes main unit 10 comprising camera 11, customer display 12, shop staff display 13, keyboard 14, receipt output unit 15, and bar-code reader 16.

Camera 11 captures an image of customers at the cashier counter. Customers at the cashier counter may be those who are going to pay for what they have bought. However, actions taken by customers are not limited to making payments, but may be asking questions to shop staff. In FIG. 1, the customers who are going to pay are customer A as a parent and customer B as the child of the parent. The broken lines in FIG. 1 represent an image-capturing range of camera 11. Camera 11 captures a succession of images at a rate of several frames per second, acquiring images (image information) of the customers at the cashier counter. In FIG. 1, since customer A and customer B are positioned in the image capturing range, camera 11 captures images of customer A and customer B. In FIG. 1, it is desirable for camera 11 to be positioned near customer display 12. Camera 11 may be referred to as an image capturing means.

Customer display 12 displays accounting information and customer information for a customer at the cashier counter. The accounting information refers to information representing accounting details. For example, the accounting information refers to information representing the names of items of merchandise which the customer is going to buy and the unit prices of the items of merchandise (also referred to as merchandise information). The customer information refers to information which is useful to the customer when it is shown to the customer. For example, the customer information refers to information about benefits given to the customer, e.g., discounts or giveaways, information about campaigns or events given by the shop or manufacturers or the like, and information about items of merchandise for which the shop or manufacturers or the like do sales promotions. The customer information may refer to information for giving guidance about facilities, etc. in the shop or general information not directly related to the shop (news, weather forecasts, traffic information, bits of knowledge, quizzes). In FIG. 1, customer display 12 is divided into two upper and lower display areas. Upper display area 12a displays accounting information, and lower display area 12b displays customer information. Customer display 12 may be referred to as a customer display means.

Shop staff display 13 displays accounting information, etc. for a shop staff member at the cashier counter (shop staff member C in FIG. 1). Shop staff display 13 is oriented toward the shop staff member. Therefore, the customers are unable to see details displayed on shop staff display 13.

Keyboard 14 includes a plurality of buttons which are operated by the shop staff member at the cashier counter when the shop staff member enters certain information.

Receipt output unit 15 prints and outputs a receipt to be given to a customer after the customer has paid. The receipt may bear customer information in addition to accounting information printed thereon. Receipt output unit 15 may be referred to as a receipt output means.

Bar-code reader 16 optically reads a bar code attached to an item of merchandise purchased by a customer to acquire merchandise information thereof. The merchandise information refers to information about the item of merchandise. The merchandise information represents the name or unit price of the item of merchandise. Bar-code reader 16 may read information other than bar-code information. Bar-code reader 16 may be referred to as a merchandise information acquiring means.

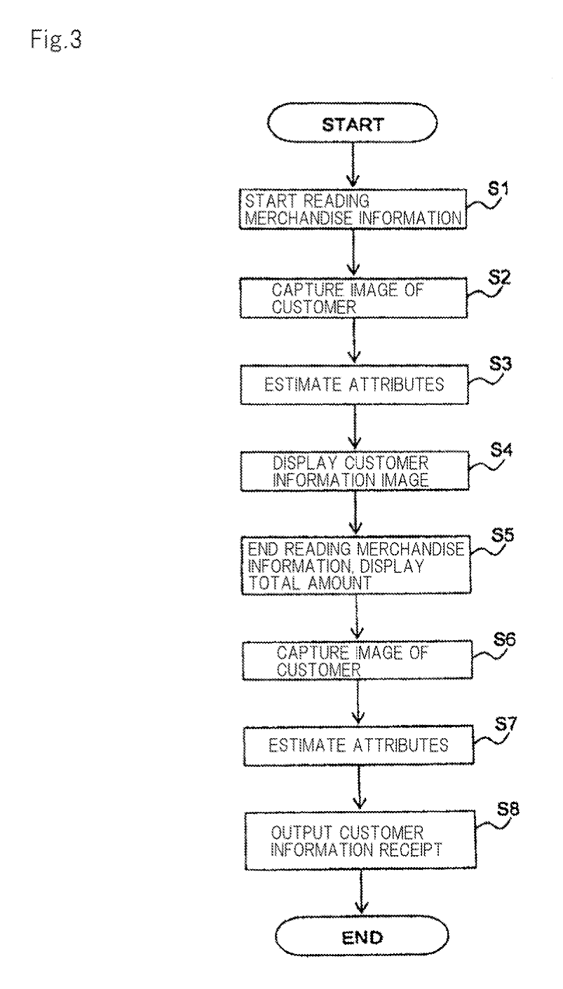

Functions of main unit 10 will be described below. FIG. 2 is a block diagram of the functional configuration of main unit 10. Main unit 10 has hardware components including a controller (control circuit), a storage medium, a calculating circuit, an image processing circuit, and a communication interface circuit. These hardware components realize the functions indicated by reference numerals 20 through 26 shown in FIG. 2. The controller comprises a CPU (Central Processing Unit), a ROM (Read Only Memory), and a RAM (Random Access Memory). The storage medium comprises an HDD (Hard Disk Driver) or the like, for example. Reference numerals 11 through 16 in FIG. 2 have already been described with reference to FIG. 1, and will not be described below.

Accounting processor 21 performs an accounting process which is a basic function of the POS apparatus. Accounting processor 21 acquires merchandise information (an example of accounting information) entered from keyboard 14 or bar-code reader 16, and calculates the total amount of money to be paid (an example of accounting information) based on the unit prices included in the merchandise information. Accounting processor 21 is implemented by the calculating circuit.

Image processor 22 acquires an image input from camera 11, estimates attributes of a customer included in the image, and acquires attribute information representative of the estimated attributes. The attributes may represent age or gender, for example. The attributes may also represent a race (easterner or westerner), clothing (suit, school uniform, hat, eyeglasses, clothing color, etc.), group information (family, mother and child, student group, etc.), a body height, etc. Attributes may be estimated according to the existing technology. The existing technology for estimating age, gender, and race, for example, is disclosed in an article published in ICMI 2005 “Principal Component Analysis of Gender, Ethnicity, Age and Identity of Face Images” Samarasena Buchala, Neil Davery, Tim M. Gale, Ray J. Frank, Procs of IEEE ICMI 2005: 7th International Conference on Multimodal Interfaces). The existing technology for recognizing clothing or hairstyle, for example, is disclosed in “A Method of Gender Classification by Integrating Facial, Hairstyle, and Clothing Images (Kazuya Ueki, Hiromitsu Komatsu, Satoshi Imaizumi, Kenichi Kaneko, Satoshi Imaizumi, Nobuhiro Sekinc, Jiro Katto, Tetsunori Kobayashi)”. If an image input from camera 11 includes a plurality of customers, then image processor 22 estimates attributes of each of the customers and acquires attribute information of each of the customers. Image processor 22 is implemented by the image processing circuit. Image processor 22 may be referred to as an attribute information acquiring means.

Image processor 22 may have a measuring function to measure at least one of the face angle, face position (coordinates), and face size (area, number of pixels) of a customer in an image captured by camera 11. Image processor 22 may also have a determining function to determine whether the measured value acquired by the measuring function has agreed with a preset value or not. Image processor 22 may also have a time measuring function to measure a time during which the measured value acquired by the measuring function has maintained a prescribed value (e.g., the above preset value), or to measure a time during which an image of a customer is captured. Furthermore, image processor 22 may have a time determining function to determine whether the time measured by the time measuring function has reached a preset time or not.

The above functions enable image processor 22 to determine whether a customer in an image captured by camera 11 is in a prescribed state or not. For example, a situation for determining whether a customer in an image is watching customer display 12 or not will be described below. There are preliminarily set in image processor 22 preset values representative of a face angle, a face position, and a face area which are required for the customer to watch customer display 12, and a preset time during which the preset values are to be maintained. Image processor 22 measures the face angle, face position, and face area of the customer in the image, and determines whether the measured values agree with the preset values or not. If the measured values agree with the preset values, then image processor 22 measures times during which the measured values have maintained the preset values, and determines whether the measured times have reached the preset time or not. If the measured times have reached the preset time, then image processor 22 judges that the customer in the image is watching customer display 12. Image processor 22 estimates attributes of the customer and acquires attribute information representative of the estimated attributes. In this manner, if the image captured by camera 11 includes a plurality of customers, then image processor 22 can identify a customer who is watching customer display 12 from among the customers. In the above example, the face angle, face position, and face area are all measured and determined. However, any one of them may be measured and determined.

Display controller 23 controls customer display 12 and shop staff display 13 to display images. Display controller 23 outputs customer information and accounting information, for example, to customer display 12 to display the customer information and accounting information on customer display 12. The customer information may be information that has been associated with attribute information acquired by image processor 22 in its attribute estimating process. The customer information may be presented in either a still image or a moving image. If the attribute information represents a plurality of attributes, then display controller 23 displays the items of customer information which are associated with the attributes successively on the customer display 12. The accounting information may be merchandise information input from bard-code reader 16 or a total amount of money to be paid which has been calculated by accounting processor 21.

Display controller 23 outputs attribute information and accounting information, for example, to shop staff display 13, to shop staff display 13 to display the customer information and accounting information on customer display 12. The attribute information may represent, for example, attributes that are acquired by image processor 22 in its attribute estimating process. The accounting information may represent, for example, merchandise information input from bar-code reader 16 or the total amount of money to be paid which is calculated by accounting processor 21. Display controller 23 is implemented by the controller. Display controller 23 and customer display 12 may be referred to as a customer information output means.

Receipt output controller 24 controls receipt output unit 15 to output a receipt. Receipt output controller 24 outputs accounting information and customer information, for example, to receipt output unit 15 to enable receipt output unit 15 to print the accounting information and the customer information on a medium of paper or the like, and output the printed medium as a receipt. The accounting information may represent, for example, a payment time and a cashier of the shop, etc. in addition to the merchandise information input from bar-code reader 16 and the total amount of money to be paid which has been calculated by accounting processor 21. The customer information may represent, for example, information associated with attribute information that is acquired by image processor 22 in its attribute estimating process. Receipt output controller 24 is implemented by the controller. Receipt output controller 24 and receipt output unit 15 may be referred to as a customer information output means.

Information storage unit 25 shops various items of information. The various items of information may represent, for example, accounting information (including merchandise information) output from accounting processor 21, attribute information and images output from image processor 22, and customer information acquired from outside the POS apparatus. The customer information that is stored in information storage unit 25 is associated with various attributes, so that it may be sorted out as customer information for customers which are ten years old or younger, customer information for female customers in their twenties, and customer information for male customers in their fifties or older, for example. Furthermore, the customer information is additionally classified, e.g., the customer information for customers who are ten years old or younger is classified into customer information for display which is to be displayed on customer display 12 and customer information for receipts which is to be printed by receipt output unit 15. The customer information for display and the corresponding customer information for receipts should preferably be associated by identifiers (ID) or the like.

Information storage unit 25 may store the various items of information in relation to each other. For example, information storage unit 25 may store the accounting information (merchandise information) and the attribute information in relation to each other. By subsequently using the related information, it is possible to analyze the attributes of purchasers for different items of merchandise or different times zones. The related information can thus be useful for marketing purposes.

In FIG. 2, main unit 10 includes one information storage unit 25. However, main unit 10 may include information storage for the respective various items of information. Information storage unit 25 is implemented by the storage medium.

External communication unit 26 communicates with devices and networks outside the POS apparatus, and sends and receives the above various items of information. The customer information shop in information storage unit 25 may be received anytime via external communication unit 26. External communication unit 26 is implemented by the communication interface circuit.

General controller 20 links above components 21 through 26 with each other, and controls the realization of the functions of above components 21 through 26. General controller 20 is implemented by the controller.

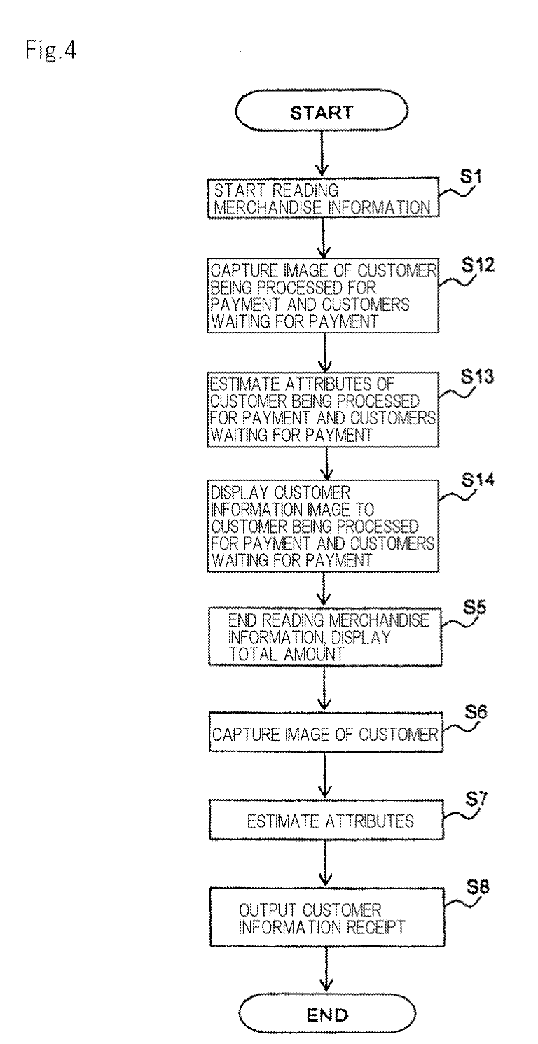

A processing sequence of the POS apparatus according to the present exemplary embodiment, which is configured as described above, will be described below with reference to FIGS. 1 through 3. FIG. 3 is a flowchart of an operation sequence of the POS apparatus according to the present exemplary embodiment.

It is assumed, for example, that as shown in FIG. 1, customer A as a parent and customer B as the child of the parent have come to a cashier counter to pay for their purchase, and that the cashier counter is attended by shop staff member C who deals with the payment by using the POS apparatus according to the present exemplary embodiment. Customer A and customer B hand a plurality of items of merchandise which they are going to buy to shop staff member C. Shop staff member C uses bard-code reader 16 to read the bar codes attached to the handed items of merchandise one by one (step S1). Merchandise information read from the bar codes is input to accounting processor 21 and is also displayed in display area 12a of customer display 12 and shop staff display 13 under the control of display controller 23. At this time, display area 12b of customer display 12 displays letters “WELCOME” or the like, for example.

When the bar code of the first item of merchandise is read by shop staff member C, camera 11 captures and acquires an image of the image-capturing range thereof (step S2). It is assumed that the image-capturing range covers a location where a customer is positioned for payment. In the present example, as shown in FIG. 1, camera 11 captures an image of customer A and customer B in the image capturing range.

The image that is captured by camera 11 is input to image processor 22. Image processor 22 estimates attributes of customer A and customer B included in the image input thereto (step S3). In this example, the estimated attributes of customer A represent “41-year-old female” and the estimated attributes of customer B represent “9-year-old male”. Image processor 22 then outputs attribute information which indicates the estimated attributes to display controller 23.

Display controller 23 acquires customer information for display, which is associated with the input attribute information, from information storage unit 25, and successively displays the acquired customer information in area 12b of customer display 12 (step S4). In this example, it is assumed that information storage unit 25 stores, for example, customer information for females in their forties (e.g., an image for advertising cosmetics) and customer information for customers which are ten years old or younger (e.g., an image for announcing kids events), which have been acquired via external communication unit 26 in advance. Consequently, display controller 23 can acquire both customer information corresponding to the attribute information “41-year-old female” and “9-year-old male”.

When shop staff member C has read bar codes of all items of merchandise and presses all the keys of keyboard 14, accounting processor 21 outputs a calculated total amount of money to be paid to display controller 23. Display controller 23 displays the total amount of money to be paid in area 12a of customer display 12 (step S5), as shown in FIG. 1.

When the total amount of money to be paid is displayed or within a prescribed time after the total amount of money to be paid is displayed, camera 11 captures an image of customer A and customer B in the image capturing range (step S6).

The image that is captured by camera 11 is input to image processor 22. Image processor 22 identifies one of customer A and customer B included in the input image who has watched customer display 12, based on the measuring function and the determining function thereof. In this example, it is assumed that customer A looks at the displayed total amount of money for two seconds, and that the measured values of the size, position, and angle of the captured image of the face agree with preset values, and that the time for which the measured values agree with the preset values has reached a preset time. Customer A is thus identified as a customer which has watched customer display 12. Image processor 22 estimates attributes of identified customer A, and acquires attribute information “41-year-old female” representative of the estimated attributes (step S7). Image processor 22 then outputs the acquired attribute information to receipt output controller 24.

When receipt output controller 24 detects an input signal from a key that is depressed by shop staff member C upon completion of the payment, receipt output controller 24 acquires customer information for receipts which is associated with the input attribute information from information storage unit 25, and controls receipt output unit 15 to print the customer information for receipts (step S8). In this example, it is assumed that information storage unit 25 stores customer information for females in their forties (e.g., an article for advertising cosmetics), which has been acquired via external communication unit 26 in advance. Receipt output controller 24 can thus acquire customer information corresponding to the attribute information “41-year-old female”. When the outputting of the receipt from receipt output unit 15 is finished, display controller 23 ends the display of the customer information in area 12b of customer display 12, and displays letters “THANK YOU” or the like.

According to the present exemplary embodiment, as described above, attributes of customers who pay at the cashier counter are to be estimated, and information is provided with respect to each of the customers. Consequently, information suitable for each of the customers is reliably provided with good timing. The reasons for providing information with good timing are as follows: Since a certain period of time is required during which payment is to be paid, information can be provided during that time. Basically, since a payment process is performed between the shop staff member and one customer at a time, rather than between the shop staff member and a plurality of customers at the same time, appropriate information can be provided only for the customer who is being processed for payment. According to the present exemplary embodiment, furthermore, as information is provided immediately using the estimated attributes of customers, it is not necessary to acquire and register the data of customers in advance each time each of the customers comes to the shop, as with Patent document 1.

Supplemental examples of the exemplary embodiment will be described below.

### SUPPLEMENTAL EXAMPLE 1

In the processing sequence shown in FIG. 3, steps S6 through S8 may be optional. For example, after the total amount of money to be paid is displayed in step S5, the receipt may be output without capturing an image of the customers and estimating attributes again.

At this time, the receipt may include printed customer information (for receipts) which is associated with at least one piece of the customer information (for display) successively displayed on customer display 12. Such a process will be described below with reference to the processing sequence shown in FIG. 3. In step S3, image processor 22 outputs the attribute information “41-year-old female” and “9-year-old male” to not only display controller 23, but also receipt output controller 24. Receipt output controller 24 acquires customer information (for receipts) associated respectively with the customer information (for display) for females in their forties and the customer information (for display) for customers who are ten years old or younger, from information storage unit 25 based on identifiers. Then, receipt output controller 24 controls receipt output unit 15 to print both the customer information (for receipts) for females in their forties and the customer information (for receipts) for customers who are ten years old or younger, on a receipt. The printed customer information may be either the customer information (for receipts) for females in their forties or the customer information (for receipts) for customers who are ten years old or younger.

### SUPPLEMENTAL EXAMPLE 2

Prior to step S1 shown in FIG. 3, i.e., before bar-code reader 16 reads the bar codes, customer information (for display) may be displayed on customer display 12. For example, display controller 23 may randomly acquire customer information (for display) from information storage unit 25, and successively display the acquired customer information (for display) in area 12b of customer display 12. Alternatively, display controller 23 may count the number of times that it has acquired and displayed customer information (for display), with respect to each of the customer information (for display), acquire customer information (for display) from information storage unit 25 depending on the displayed count (acquired count), and display the acquired customer information (for display) in area 12b of customer display 12.

### SUPPLEMENTAL EXAMPLE 3

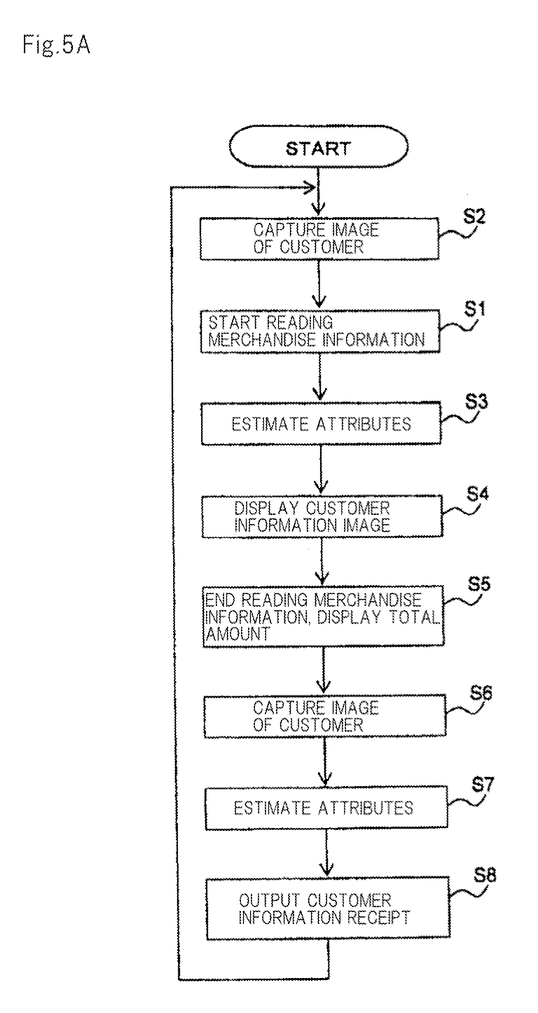

If there is a line of customers waiting for payments at the cashier counter, then camera 11 may capture an image of the customer behind the customer who is currently being processed for a payment, and attributes of the imaged customer may be estimated before the customer pays. An operation sequence of Supplemental example 3 is illustrated in FIG. 4. Those steps shown in FIG. 4 which are identical to the steps shown in FIG. 3 are denoted by identical reference characters, and will not be described below. Steps S12 through S14 shown in FIG. 4 will mainly be described below. It is assumed that customers A and B shown in FIG. 1 are currently being processed for a payment, and customer D is waiting for a payment behind customers A and B. When customers A and B start being processed for a payment by reading the bar codes attached to the items of merchandise (step S1), camera 11 captures not only an image of customers A and B, but also customer D who is waiting for a payment, and acquires the captured images (step S12). The image captured by camera 11 is input to image processor 22. Image processor 22 estimates attributes of customers A, B, D included in the image input thereto (step S13). Image processor 22 outputs attribute information representative of the estimated attributes to display controller 23. Display controller 23 acquires customer information for display, which is associated with the input attribute information, from information storage unit 25, and successively displays the acquired customer information in area 12b of customer display 12 (step S14). The steps following step S14 are identical to step S5 and subsequent steps shown in FIG. 3, and will not be described below. Accordingly, it is possible to display an advertisement to not only the customer who is being processed for a payment, but also a customer waiting for a payment. A customer display for waiting customers may be included in addition to customer display 12. The customer display for waiting customers displays customer information (for display) depending on the attributes of a customer waiting for a payment, separately from customer information displayed on customer display 12.

### SUPPLEMENTAL EXAMPLE 4

Camera 11 may be installed at a location that faces a customer head-on when the customer pays.

### SUPPLEMENTAL EXAMPLE 5

If a customer gazes at customer display 12 which is displaying customer information (for display) over a prescribed time, then customer information (for receipts) associated with the customer information (for display) may be output to a receipt. Image processor 22 can identify a customer who is gazing at customer display 12 based on the measuring function and the determining function referred to above. Specifically, image processor 22 measures at least one of the values from among the face angle and face size of a customer in an image captured by camera 11, and determines whether the measured value has agreed with a preset value or not. Then, image processor 22 measures a time for which the measured value has agreed with the preset value, and determines whether the measured time reached a preset time or not. If the measured time reached the preset time, then image processor 22 judges that the customer information (for display) that is being displayed has been gazed at for a prescribed time, and outputs an identifier of the customer information (for display) that is being displayed to receipt output controller 24. Based on the identifier of the customer information (for display), receipt output controller 24 acquires customer information (for receipts) associated with the customer information (for display). Receipt output controller 24 controls receipt output unit 15 to print the acquired customer information (for receipts) on a receipt.

In Supplemental example 5, the contents of the customer information to be printed on a receipt may vary depending on the time for which the customer gazes at customer display 12. For example, if a discount coupon is to be printed as the customer information on a receipt, then the discount rate of the discount coupon is set to increase as the gazing time is longer. In this case, information storage unit 25 shops in advance a plurality of customer information (for receipts) having different discount rates for different gazing times. If there is a customer having such a face angle who gazes at customer display 12 which is displaying certain customer information (for display), then image processor 22 measures a time (gazing time) for which the face angle is maintained. Image processor 22 then outputs an identifier of the customer information (for display) which is being displayed and the measured gazing time, for example, to receipt output controller 24. Based on the identifier of the customer information (for display) and the measured gazing time, receipt output controller 24 acquires customer information (for receipts) corresponding to the measured gazing time, among the customer information (for receipts) associated with the customer information (for display), from information storage unit 25. Then, receipt output controller 24 controls receipt output unit 15 to print the acquired customer information (for receipts) on a receipt. The gazing time, which has been described above as a time for which the face angle is maintained, may instead be a time for which the image of the customer is captured.

### SUPPLEMENTAL EXAMPLE 6

Customer information should preferably be output in a format depending on an attribute. For example, customer information of elderly people is output in large letters on displayed images or printed receipts so as to be seen easily, and customer information of children is output in single-syllable letters and pictures on displayed images or printed receipts.

### SUPPLEMENTAL EXAMPLE 7

Customer information to be output may include not only attribute information but also other elements. The other elements include a time zone or weather, for example. Customer information that is stored in information storage unit 25 may be associated with not only various attributes but also a time zone or weather, for example. Information representative of a time zone (time zone information) is measured by a timer incorporated in accounting processor 21, for example. Information representative of weather (weather information) is acquired from an external server via external communication unit 26, for example. Display controller 23 and receipt output controller 24 receive attribute information from image processor 22, and also receive time zone information from accounting processor 21 and weather information from external communication unit 26. Then, display controller 23 and receipt output controller 24 acquire customer information associated with the attribute information, the time zone information, and the weather information which have been received, from information storage unit 25, and output the acquired customer information. The other elements may be either a time zone or weather, or may be something other than a time zone and weather.

### SUPPLEMENTAL EXAMPLE 8

Display controller 23 and receipt output controller 24 may control the output probability of customer information with respect to merchandise information depending on the number of items of merchandise information acquired by bar-code reader 16. Specifically, accounting processor 21 counts acquired items of merchandise information for each type of merchandise information. When the number of items of merchandise information of a certain type has reached a prescribed number, accounting processor 21 outputs an identifier indicative of customer information with respect to the merchandise information to display controller 23 and receipt output controller 24. When Display controller 23 and receipt output controller 24 acquire customer information associated with attribute information, they preferentially acquire customer information associated with the received identifier. For example, depending on the number of discount coupons used, each with a bar code printed on a receipt, receipt output controller 24 increases the output probability of the discount coupons. For example, depending on the number of items of merchandise displayed for advertisement on customer display 12, display controller 23 increases the display probability of customer information about the merchandise.

### SUPPLEMENTAL EXAMPLE 9

Shop staff display 13 may display estimated attributes, and a shop staff member may see the displayed estimated attributes and revise or add estimated attributes. Keyboard 14 allows customer attributes to be manually entered. Therefore, keyboard 14 may be referred to as an attribute input means. When display controller 23 receives attribute information from image processor 22, display controller 23 displays an attribute or attributes represented by the attribute information on shop staff display 13 for the shop staff member to confirm the displayed attribute. If the shop staff member wants to revise the displayed attribute or attributes or add another attribute or attributes to the displayed attribute or attributes, the shop staff member operates keyboard 14 to enter a new attribute or attributes which the shop staff member has estimated. The additional attribute information representing the attribute or attributes entered by the storage staff member is input to accounting processor 21 and then related to the attribute information or applied to overwrite the attribute information. Thereafter, the additional attribute information is stored in information storage unit 25 or sent to an external device via external communication unit 26.

### SUPPLEMENTAL EXAMPLE 10

The contents of customer information may not necessarily be contents related to the shop concerned. Specifically, in a complex facility such as a department store, the shop incorporating the POS apparatus according to the present exemplary embodiment collects in advance advertisements (advertisements for each attribute) about other shops in the same facility from those other shops, and stores the collected advertisements as customer information in information storage unit 25. Display controller 23 and receipt output controller 24 display images and print receipts bearing the advertisements about the other shops. In this case, display controller 23 and receipt output controller 24 should preferably total the number of output advertisements for each attribute.

### SUPPLEMENTAL EXAMPLE 11

Display controller 23 may display a questionnaire on customer display 12 and accept answers to the questionnaire. Specifically, information storage unit 25 stores questionnaire information associated with various attributes. When display controller 23 receives attribute information from image processor 22, display controller 23 acquires customer information and questionnaire information which are associated with the received attribute information. Display controller 23 displays the customer information on customer display 12, and thereafter displays a questionnaire and accepts answers from the customer. Customer display 12 comprises a touch panel. The customer touches the screen with a finger to select answers. The questionnaire should preferably include simple questions such as two-choice or three-choice questions. The shop and makers (sponsors) can have answers to questionnaires depending on attributes. The answers to questionnaires may be related to attribute information and accounting information (merchandise information).

### SUPPLEMENTAL EXAMPLE 12

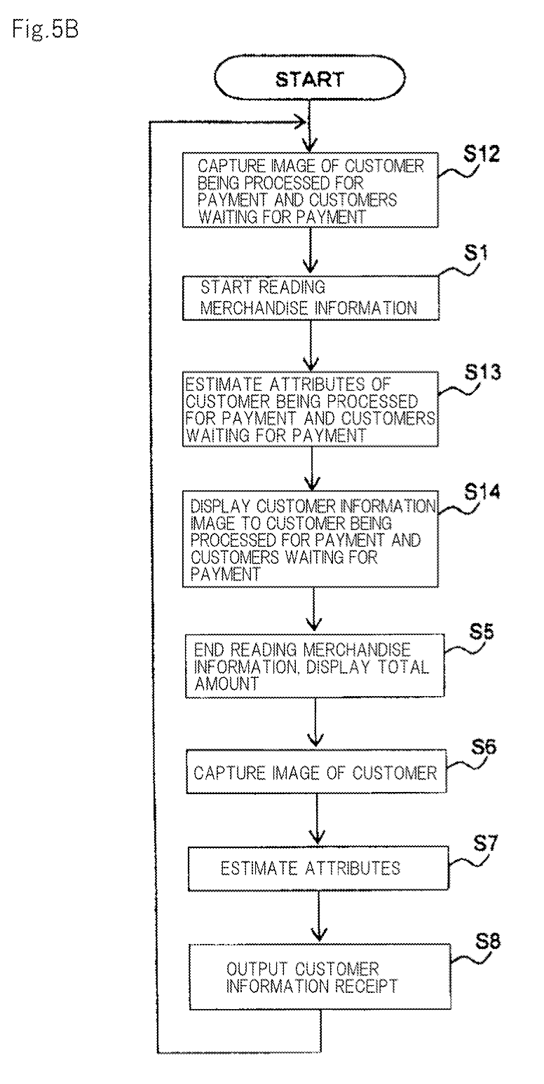

Steps S1, S2 shown in FIG. 3 and steps S1, S12 shown in FIG. 4 may be switched around, so that a customer makes a payment after its image is captured. FIG. 5A is a flowchart of an operation sequence in which steps S1, S2 shown in FIG. 3 are switched around. FIG. 5B is a flowchart of an operation sequence in which steps S1, S12 shown in FIG. 4 are switched around. Furthermore, as shown in FIGS. 5A and 5B, control may go back from step S8 to the first customer image capturing step (S2, S1) to repeat the loop. Specifically, while the POS apparatus is not performing a payment process, it captures images of customers at all times. The POS apparatus can thus quickly display customer information to customers who have come to the cashier counter for payments, and can also display customer information to customers who are waiting for payments. In this sense, the present example is applicable to Supplemental example 3. The steps shown in FIGS. 5A and 5B have been described above with reference to FIGS. 3 and 4, and will not be described below.

A POS apparatus, for example, has been described above as the information providing apparatus according to the exemplary embodiment of the present invention. However, the information providing apparatus according to the present invention is not limited to a POS apparatus, but may be applied to an automatic dispensing machine (including a machine which provides articles for free), an ATM (Automatic Tellers Machines), a checkout machine, etc. In other words, the information providing apparatus according to the present invention is applicable to apparatus and machines which are incapable of dealing with a plurality of customers at the same time and are capable of maintaining a certain time for dealing with each customer.

Although the exemplary embodiment of the present invention has been described above, the present invention is not limited to the above exemplary embodiment, and various changes and modifications may be made without departing from the scope of the invention.

For example, the functions and operation sequences in the above exemplary embodiment may be executed by hardware, software, or a combination of hardware and software.

If the functions and operation sequences are executed by software, then programs which have recorded processing sequences may be installed in a memory in a computer which is incorporated in dedicated hardware, and then executed. Alternatively, the programs may be installed in a general-purpose computer which is capable of performing various processes, and then executed.

For example, the programs may be recorded in advance in a hard disk or a ROM (Read Only Memory) as a recording medium. Alternatively, the programs may be temporarily or permanently stored (recorded) in a removable recording medium such as a CD-ROM (Compact Disc Read Only Memory), a MO (Magnetooptical) disc, a DVD (Digital Versatile Disc), a magnetic disc, or a semiconductor memory. Such a removable recording medium can be provided as so-called package software.

The programs may be installed from the above removable recording medium into the computer, or may be transferred from a downloading site to the computer via a wireless link. Alternatively, the programs may be transferred via a network such as a LAN (Local Area Network) or the Internet to the computer via a wired link. The computer can receive the transferred programs and install the programs into a recording medium such as a hard disk or the like incorporated in the computer.

The programs may be executed chronologically according to the processing sequences described in the above exemplary embodiment, or may be executed concurrently or individually either depending on the processing capability of the apparatus which carries out the processing sequences or as required.

According to the present exemplary embodiment, a POS apparatus which can acquire merchandise information and accounting information and an attribute information acquisition unit which can acquire customer attribute information are integrally combined with each other for real-time data linkage between the POS apparatus and the attribute information acquisition unit. Information based on the merchandise information, the accounting information, and the attribute information for each customer is provided on a real-time basis to provide information suitable for each customer reliably with good timing.

While the present invention has been described above with respect to the exemplary embodiment, the present invention is not limited to the above exemplary embodiment. Various changes that can be understood by those skilled in the art can be made to the configuration and details of the present invention within the scope of the present invention.

This application is based upon and claims the benefit of priority from Japanese Patent Application No. 2008-265263 filed on Oct. 14, 2008, the entire disclosure of which is incorporated herein by reference.

### DESCRIPTION OF REFERENCE CHARACTERS

10 main unit

11 camera

12 customer display

13 store staff display

14 keyboard

15 receipt output unit

16 bar-code reader

20 general controller

21 accounting processor

22 image processor

23 display controller

24 receipt output controller

25 information storage

26 external communication unit

1. An information providing apparatus comprising:
an image capturing unit that captures an image of a customer who is at a given location during a period of time;
an attribute information acquiring unit that estimates an attribute of said customer based on the image captured by said image capturing unit and acquiring attribute information representative of the estimated attribute; and
a customer information output unit that outputs customer information depending on the attribute information acquired by said attribute information acquiring unit.

2. The information providing apparatus according to claim 1, further comprising:
a merchandise information acquiring unit that acquires merchandise information with respect to merchandise purchased by the customer;
wherein the merchandise information acquired by said merchandise information acquiring unit is related to said attribute information.

3. The information providing apparatus according to claim 1, wherein if said image capturing unit captures an image of a plurality of customers, and if said attribute information acquiring unit captures attribute information representative of a plurality of attributes of said customers, said customer information output unit successively outputs customer information depending on said attributes.

4. The information providing apparatus according to claim 1, further comprising:
an attribute input unit that manually enters an attribute of said customer and that acquires additional attribute information representative of the entered attribute;
wherein said attribute information is related to said additional attribute information or is overwritten by said additional attribute information.

5. The information providing apparatus according to claim 1, wherein said attribute information acquiring unit measures at least one of a face angle, face position, and face size of said customer in the image captured by said image capturing unit, and identifies the customer in a prescribed state by determining whether a measured value maintains a preset value for a prescribed time or not; and
said attribute information acquiring unit estimates an attribute of the identified customer, and acquires attribute information representative of the estimated attribute.

6. The information providing apparatus according to claim 1, wherein said customer information output unit increases an output probability of said customer information with respect to said merchandise information depending on the number of items of merchandise information acquired by said merchandise information acquiring unit.

7. The information providing apparatus according to claim 1, wherein said customer information output unit includes at least one of customer display units that display said customer information to the customer and a receipt output unit that prints said customer information on a receipt and that outputs, the receipt.

8. The information providing apparatus according to claim 7, wherein said customer display unit displays a questionnaire as said customer information and accepts answers to said questionnaire.

9. The information providing apparatus according to claim 7, wherein said attribute information acquiring unit measures at least one of a face angle, face position, and face size of said customer in the image captured by said image capturing unit, and identifies the customer in a prescribed state by determining whether a measured value maintains a preset value for a prescribed time or not; and
if said attribute information acquiring unit identifies the customer who is gazing at said customer display unit, said receipt output unit prints the customer information displayed on said customer display unit on a receipt and outputs the receipt.

10. An information providing method comprising:
capturing an image of a customer who is at a given location during a period of time;
estimating an attribute of said customer based on the captured image and acquiring attribute information representative of the estimated attribute; and
outputting customer information depending on the acquired attribute information.

11. A recording medium recording therein a program for enabling a computer to perform:
an image capturing process for capturing an image of a customer who is at a given location during a period of time;
an attribute information acquiring process for estimating an attribute of said customer based on the image captured by said image capturing process and acquiring attribute information representative of the estimated attribute; and
a customer information output process for outputting customer information depending on the attribute information acquired by said attribute information acquiring process.
